(19) United States
(12) Patent Application Publication
(10) Pub. No.: US 2026/0270212 A1
(43) Pub. Date: Sep. 10, 2026

(54) METHODS, ARCHITECTURES, APPARATUSES AND SYSTEMS DIRECTED TO MEASUREMENT AND ADJUSTMENTS OF CO-DEPENDENT FLOWS CHARACTERISTICS

(71) Applicant: InterDigital CE Patent Holdings, SAS, Paris (FR)

(72) Inventors: Stephane ONNO, SAINT GREGOIRE (FR); Patrice HIRTZLIN, BETTON (FR); Loic FONTAINE, NOYAL SUR VILAINE (FR); Xavier DE FOY, KIRKLAND (CA); Jaya RAO, MONTREAL (CA); Michael STARSINIC, NEWTOWN, PA (US)

(21) Appl. No.: 19/167,267

(22) PCT Filed: Mar. 14, 2024
(86) PCT No.: PCT/EP2024/056883

§ 371 Date: Sep. 19, 2025

Related U.S. Application Data
(60) Provisional application No. 63/453,809, filed on Mar. 22, 2023.

(51) Int. Cl. H04L 47/283; H04W 28/02; H04W 28/08

(52) U.S. Cl. CPC H04L 47/283; H04W 28/0268; H04W 28/0273; H04W 28/0908

(57) ABSTRACT

In an embodiment, a method may be implemented in a WTRU. The WTRU may send, to a first network element, request information indicating a request to perform a replication policy of information associated with a first flow and a second flow, wherein the first flow and the second flow may be co-dependent. The WTRU may send, to a first network element, first information in the first flow and may receive, from the first network element, replicated first information from the second flow, wherein the first flow and the second flow may be co-dependent. The WTRU may determine one or more co-dependent flows characteristics associated with the first flow and the second flow based on the first information and the replicated first information. The WTRU may send second information associated with the one or more co-dependent flows characteristics.

### CROSS-REFERENCE TO RELATED APPLICATIONS

This application claims the benefit of U.S. Patent Application No. 63/453,809 filed Mar. 22, 2023, which is incorporated herein by reference in its entirety.

### TECHNICAL FIELD

The present disclosure is generally directed to the fields of communications, software and encoding, including, for example, methods, architectures, apparatuses, systems directed to measurement and adjustments of co-dependent flows characteristics.

### BACKGROUND

Extended reality (XR) may include, for example, any of augmented reality (AR) and virtual reality (VR). In XR services and applications such as, for example, any of AR and VR with interactivity, a wireless transmit/receive unit (WTRU) may interact with an XR server running, for example, on an edge computing network element to offload computationally intensive tasks, for example, for video rendering or anti-collusion calculation. Embodiments described herein have been designed with the foregoing in mind.

### BRIEF SUMMARY

Methods, architectures, apparatuses, and systems directed to measurement and adjustments of co-dependent flows characteristics are described herein. In an embodiment, a WTRU including circuitry including e.g. any of a processor, a memory, a transmitter and a receiver (e.g., a transceiver) operatively coupled to the processor is described herein. The circuitry may be configured to send, to a first network element, request information indicating a request to perform a replication policy of information associated with a first flow and a second flow, wherein the first flow and the second flow may be co-dependent. The circuitry may be configured to receive, from the first network element, acknowledge information for acknowledging the request information. The circuitry may be configured to send, to the first network element, first information in the first flow and to receive, from the first network element, replicated first information from the second flow. In various embodiments the first flow and the second flow may be co-dependent and associated with an application. The circuitry may be configured to determine one or more co-dependent flows characteristics associated with the first flow and the second flow based on the first information and the replicated first information. In an example, the circuitry may be configured to determine that a co-dependent flows characteristic may satisfy a QoS budget condition e.g., associated with the application. The circuitry may be configured to send, to a second network element, second information associated with the one or more co-dependent flows characteristics e.g., based on the determining that a co-dependent flows characteristic may satisfy the QoS budget condition.

In an embodiment, a method may be implemented in a WTRU. The method may comprise sending, to a first network element, request information indicating a request to perform a replication policy of information associated with a first flow and a second flow, wherein the first flow and the second flow may be co-dependent. The method may comprise receiving, from the first network element, acknowledge information for acknowledging the request information. The method may comprise sending, to a first network element, first information in the first flow and receiving, from the first network element, replicated first information from the second flow. In various embodiments, the first flow and the second flow may be co-dependent and associated with an application. The method may further comprise determining one or more co-dependent flows characteristics associated with the first flow and the second flow based on the first information and the replicated first information. In an example, the method may further comprise determining that a co-dependent flows characteristic may satisfy a QoS budget condition e.g., associated with the application. The method may further comprise sending, to a second network element, second information associated with the one or more co-dependent flows characteristics e.g., based on the determining that a co-dependent flows characteristic may satisfy the QoS budget condition.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a diagram illustrating two examples of XR applications;

FIG. 3 is a diagram illustrating an example of quality of service (QoS) flow information carried in transport layers;

FIG. 4 is a diagram illustrating an example method for measuring and adjusting co-dependent flows characteristics;

FIG. 5 is a diagram illustrating an example of different QoS/QoE characteristics for measurement and adjustment;

FIG. 6 is a diagram illustrating an example of different timings measurements for QoS/QoE characteristics measurements;

FIG. 7 is a diagram illustrating an example method for delay measurement based on any of real time protocol (RTP) and real time control protocol (RTCP) mark timestamps;

FIG. 8 is a diagram illustrating an example method for QoS/QoE delay adjustment exposure in forward/reverse RTP flow marks;

FIG. 9 is a diagram illustrating an example method for delay measurements and adjustments on co-dependent flows; and

FIG. 10 is a diagram illustrating another example method for delay measurements and adjustments on co-dependent flows.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

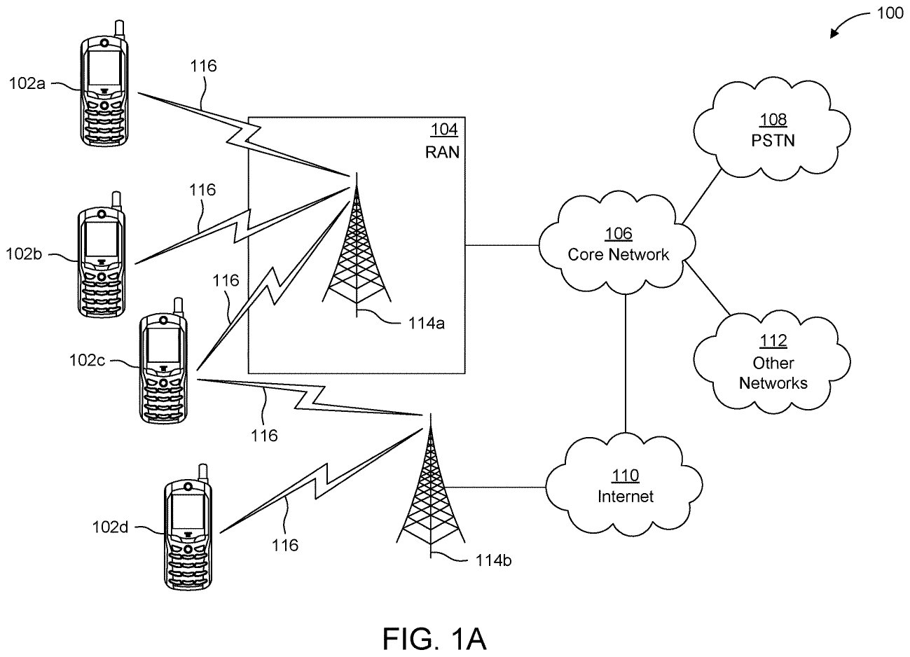

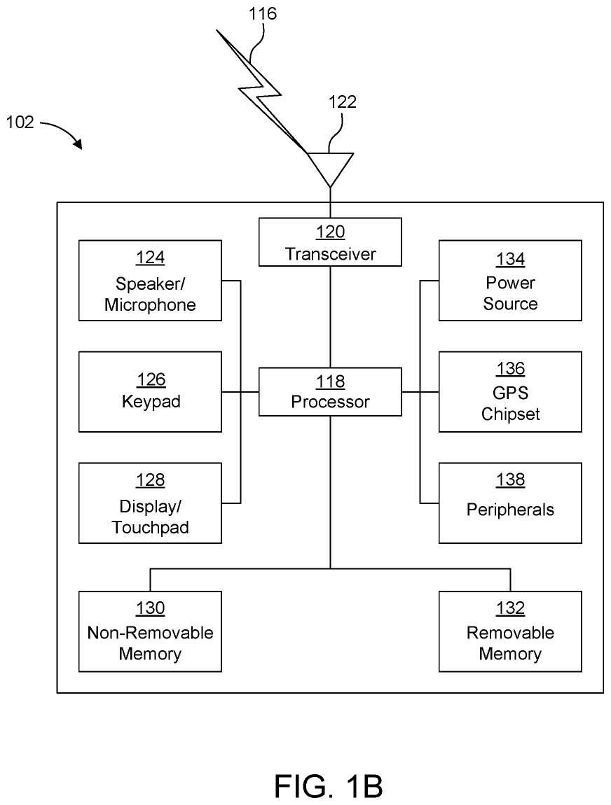

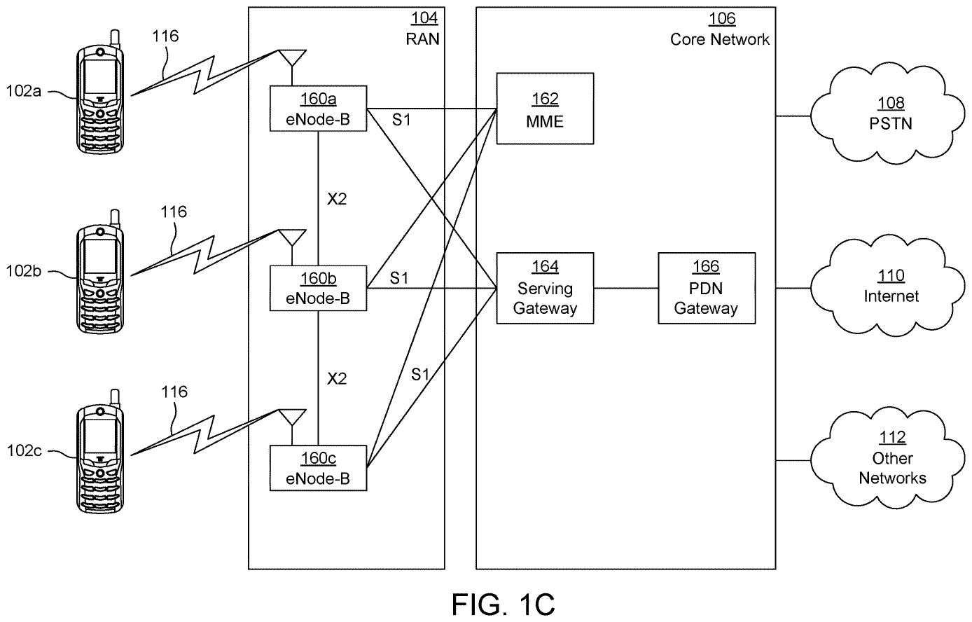

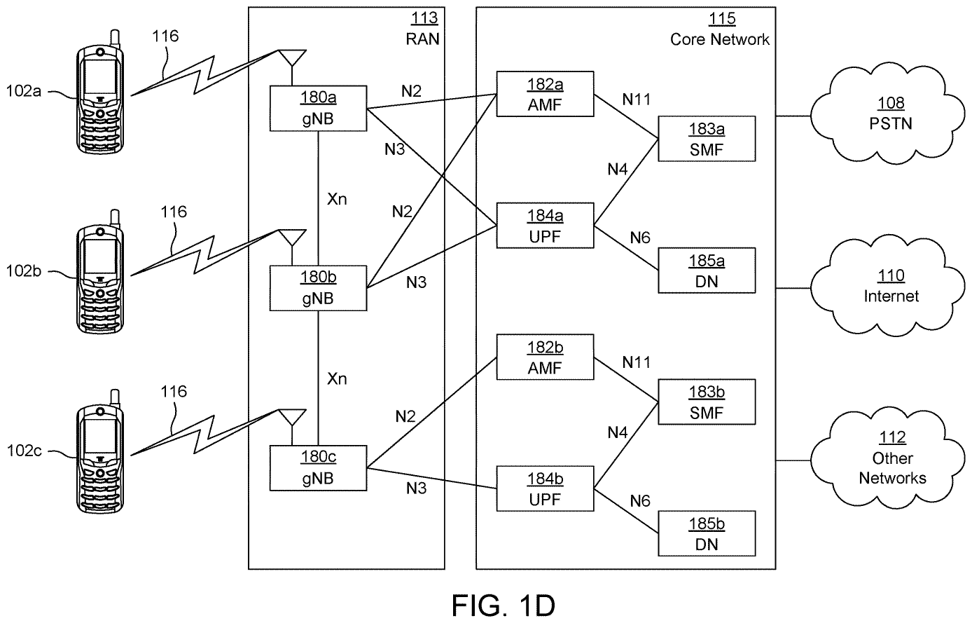

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-ID as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized by WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 182a, 182b may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

For the sake of clarity, satisfying, failing to satisfy a (e.g., QoS budget) condition and configuring condition parameter(s) are described throughout embodiments described herein as relative to a threshold (e.g., greater, or lower than) a (e.g., threshold) value, configuring the (e.g., threshold) value, etc.). For example, satisfying a (e.g., QoS budget) condition may be described as being above a (e.g., threshold) value, and failing to satisfy a (e.g., QoS budget) condition may be described as being below a (e.g., threshold) value. Embodiments described herein are not limited to threshold-based conditions. Any kind of other condition and parameter(s) (such as e.g., belonging or not belonging to a range of values) may be applicable to embodiments described herein.

Throughout embodiments described herein, (e.g., configuration) information may be described as received by a WTRU from the network, for example, through system information or via any kind of protocol message. Although not explicitly mentioned throughout embodiments described herein, the same (e.g., configuration) information may be pre-configured in the WTRU (e.g., via any kind of pre-configuration methods such as e.g., via factory settings), such that this (e.g., configuration) information may be used by the WTRU without being received from the network.

Throughout embodiments described herein the terms “serving base station”, “base station”, “gNB”, “network” collectively “gNB” may be used interchangeably to designate any network element such as e.g., a network element acting as a serving base station. Embodiments described herein are not limited to gNBs and are applicable to any other type of serving base stations.

Throughout embodiments described herein, any network element of the RAN or of the core network (CN) may be referred to herein as “the network”.

Throughout embodiments described herein, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’.

A symbol ‘/’ (e.g., forward slash) may be used herein to represent ‘and/or’, where for example, ‘A/B’ may imply ‘A and/or B’.

Throughout embodiments described herein the expressions “invoking a function (e.g., of an API)” and “sending information indicating (e.g., a request to invoke) the function (e.g., of the API)” may be used interchangeably to designate that a request message may be sent to a network element, indicating one or more parameters of the invoked function, and that a response message may be received from the network element indicating one or more response parameters of the invoked function.

Throughout embodiments described herein the expression “expose information to the network” may be used interchangeably with “sending information to a network element” to designate that the information may be made available (e.g., transmitted) to the network element, in a message that may be directed to the network element (e.g., the network element being the final destination of the message) and/or that may be processed by the network element to be to forwarded to another network element, wherein the exposed information may be intercepted and processed by the network element, based on, for example, a packet inspection technique.

Throughout embodiments described herein the terms “request (or respond)” and “send a request (or response)” may be used interchangeably with the expression “send information indicating a request (or response)”.

Throughout embodiments described herein the terms “co-dependent flows” may be used to refer to at least a first flow and a second flow having a level of dependency for meeting a QoS (e.g., QoE) objective, for example, for an application based on the co-dependent flows. The terms “first flow” and “forward flow” may be used interchangeably throughout embodiments described herein. The terms “second flow”, “reverse flow” and “backward flow” may be used interchangeably throughout embodiments described herein. Embodiments described herein may be applicable to more than one forward flow depending on (e.g., impacting, being associated with) a reverse flow.

### Overview

In embodiments described herein, a WTRU may correspond to any XR device (e.g., network element) which may be in a variety of form factors. An example of WTRU (e.g., XR WTRU) may include, and not be limited to any of the following: head mounted displays (HMD), optical see-through glasses, camera see-through HMDs for any of AR and VR, mobile devices with positional tracking and camera, wearables etc. For example, there may be different types of XR WTRUs based on (e.g., different) XR device functions, such as e.g., any of display, camera, sensors, sensor processing, wireless connectivity, XR/media processing, and power supply, to be provided by one or more devices, wearables, actuators, controllers and/or accessories. One or more devices (e.g., network elements, WTRUs) may be grouped into a collaborative XR group for supporting any of XR applications, XR experience and XR services.

In XR services and applications such as, for example, any of AR and VR with interactivity, a WTRU may interact (e.g., exchange information) with an XR server running, for example, on an edge computing network element to offload computationally intensive tasks, for example, for video rendering or anti-collusion calculation. In an example of rendering between the WTRU and an edge network element, the XR WTRU may transmit any of tracking information, sensor information, gesture information and interactivity information e.g., in uplink (UL) transmissions to a XR server. For example, the XR server may generate the XR scene based on information received from the XR WTRU. The XR server may rasterize the XR viewport, may perform XR pre-rendering and may generate a XR media which may be encoded and delivered to the XR WTRU e.g., in downlink (DL) transmissions. The XR WTRU may receive and decode the XR media. The XR WTRU may perform (e.g., latest) pose correction to address changes in the pose, and may render the (e.g., XR media in the) XR viewport.

XR applications may have (e.g., strict) round-trip expectations (e.g., requirements) to provide a level of quality of experience (QoE) for the end-user, such as, for example, a motion to photon (e.g., end to end latency) of twenty milliseconds.

Rendering any of an XR video and an XR scene may be associated with offloading processing to a more powerful compute unit, for example, in a case where a WTRU does not include sufficient computing resources. Two examples are described herein where at least a part of the processing may be done in an edge server to meet the WTRU expectations (e.g., requirements).

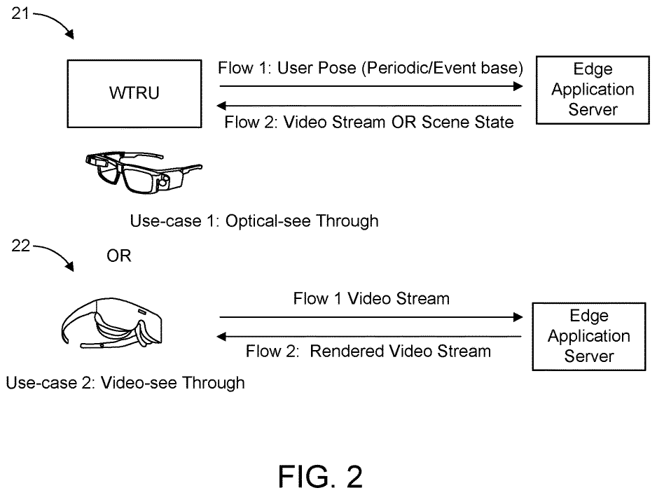

FIG. 2 is a diagram illustrating two examples 21, 21 of XR applications. In the first example 21, an optical-see through device may have limited computing and battery resources. In a case where a user runs an AR application, the AR glasses may communicate in any of a standalone manner and via a WTRU for (e.g., capturing and) transmitting its user-pose to an edge application server. In turn, the server application may process a video stream to render regarding the received pose and may send back to the AR glasses (e.g., via the WTRU) the video stream to render on the glasses. In the second example 22, a video-see through device may transmit a first video stream to the edge application server which may compute an overlayed graphical information on the top of the received video before sending back the rendered video stream to the VR headset (e.g., video-see through device).

### Overview of 5G Core API Exposure for Round Trip Latency

An application function (AF) may invoke an application programming interface (API) (such as e.g., Npcf_Policy Authorization) to provide the 5G core (5GC) with a round-trip (RT) latency (e.g., requirement, budget) for any of an uplink flow and a downlink flow. For example, the RT latency (e.g., requirement, budget) may indicate the allowable sum of the downlink delay and the uplink delay. The uplink delay and downlink delay may be delays between the WTRU and the network termination point, which may be referred to herein as N6 (such as e.g., the network element running the UPF). The 5GC may monitor the delay on the associated downlink and uplink paths and may adjust the packet delay budget on any of the downlink path and uplink path to meet the RT latency (e.g., requirement, budget). For example, in a case where the delay on the uplink path is observed to be larger than the delay on the downlink path, the 5GC may provision a larger packet delay budget on the uplink path and a smaller packet delay budget on the downlink path if the sum of the two values do not exceed the RT latency (e.g., requirement, budget).

The 5GC API may not be used to control the end-to-end round-trip time latency (e.g., the delay between the WTRU and the application server). The 5GC may not be aware of the latency between the N6 termination point and the application server.

Preconfigured QoS settings may not be well adapted for XR applications, which may be based on variable network usage to maintain a QoE. The processing and bandwidth for a video stream produced by an edge server may be variable and may depend on any of the user-pose variation and the complexity of rendering a scene. The underlying network may manage its resources based on preconfigured QoS flow resource allocation between the application and the network.

Real time delay QoS/QoE expectations (e.g., requirements, objectives) may not be met at application level (e.g., only). The QoS/QoE expectations (e.g., requirements, objectives) for the end-user, including high quality content in time, strict RTT delays such as motion-to-photon may not be met by the application by increasing buffers or by post-processing pose correction, such as e.g., asynchronous time-warping. For example, real time communications and protocols may be used to meet the real time expectations (e.g., requirements, objectives). Not meeting these real time expectations (e.g., requirements, objectives) may result in any of packet losses and a poor QoE for the end-user.

The end user QoE may be considered globally and not from the independent configuration flow: The WTRU may interact with the network (e.g., RAN/CN) to establish different independent uplink and downlink flows, for example, to allocate or adjust the QoS of a flow regarding any of the uplink and the downlink packet delay budget (PDB) settings. The end user QoE may depend on round-trip characteristics (e.g., requirements) including an uplink flow transmitted by the WTRU and a downlink flow transmitted by the application server.

The remote edge server may not interact (e.g., directly) with the network (e.g., RAN/CN) to configure flows. An XR application may involve split rendering to meet strict device, application, and latency objectives (e.g., requirements). For these settings, the WTRU may interact with the edge server for providing an application that may configure one or more forward and/or reverse flows. For example, the WTRU may (e.g., only) interact with the network via the RAN and may not be able to measure how the different flows may impact the QoE to enforce the objectives (e.g., requirements) above.

The network may not share network capabilities with the application. For example, an XR application may request network resources that may be shared and adjusted between different users and applications according to available resources that may be limited and scarce. The network may adjust the resources for energy saving purposes. The network may not be aware at a given time whether the application may expect more resources or whether the network may have allocated resources that may not be used.

### Flow Overview

Different media data service flows are shown in FIG. 2. For example, a forward media flow, illustrated as “Flow 1” and a reverse media flow illustrated as “Flow 2” may be referred to as dependent or co-dependent, based on the reverse media flow being built from input from the forward media flow.

A “forward” (e.g., data, media) flow may refer to a one-way flow (e.g., uplink in the examples of FIG. 2), with, for example, acks in the other direction. A “reverse” (e.g., data, media) flow may refer to a one-way flow (e.g., downlink in the examples of FIG. 2), with, for example, acks in the other direction.

As illustrated in FIG. 2, a forward flow may be an applicative (e.g., media) flow, for example, including any of user pose, user interaction data. The reverse flow may be another applicative (e.g., media) flow, for example, including any of the rendered video stream and an updated scene state for XR.

Any of a forward and a reverse flow may include any transport protocol connection (same or different). Any of a forward and a reverse flow may be transported over (e.g., based on) any of a reliable (e.g., transport control protocol (TCP), quick user data protocol (UDP) Internet connection (QUIC) and unreliable (e.g., UDP) transport.

In a first example, the forward flow may comprise a first real time protocol (RTP) stream, and the reverse flow may comprise a second RTP stream.

In a second example, the forward flow may comprise a RTP stream, and the reverse flow may comprise a TCP connection.

In a third example, the forward flow may comprise a first QUIC connection, and the reverse flow may comprise a second QUIC connection.

Embodiments described herein may be applicable to co-dependent application flows between more than two devices (e.g., network elements), such as e.g., between a WTRU, an edge network element and a server network element. For the sake of clarity, embodiments are described herein by describing any processing performed behind the edge server as performed by the edge server. Embodiments described herein may be applicable to any other configuration where the edge processing may be distributed over more than one network elements.

### Overview

A (e.g., client application running in a) WTRU may A) configure a server side application (e.g., running in a (e.g., edge, cloud) network element) to measure co-dependent applicative/network flows characteristics (e.g., metrics) and/or co-dependent applicative QoE characteristics (e.g., metrics) for a round-trip communication comprising sending and receiving information on co-dependent forward and reverse flows and, B) expose related co-dependent flows information and adjustments to the network layer according to different embodiments described herein.

In a first embodiment, the client WTRU application may communicate with the server to determine co-dependent round-trip flows characteristics according to the following steps:

In a first step, the client WTRU application may send co-dependent flows information in a forward flow to the server-side application.

In a second step, the reception of an identified co-dependent flows information in the forward flow from the WTRU by the server may trigger the server-side application for preparing the replication to the reverse flow, where the co-dependent flows information may comprise a co-dependent flows mark information element (IE).

In a third step, the server-side application may receive a first application data unit from the forward flow, may output a second application data unit associated with the co-dependent flows mark IE.

In a fourth step, the server-side application may process the second application data unit and may instruct the server to replicate the co-dependent flows information in the reverse flow.

In a fifth step, the reception of an identified co-dependent flows information in the reverse flow from the server may trigger the WTRU to process one or more co-dependent flows round-trip characteristics, where the co-dependent flows information may comprise a co-dependent flows mark IE.

In a sixth step, the WTRU may determine the one or more co-dependent flows round-trip characteristic(s) from the received co-dependent flows information.

In a first example, the co-dependent flows information may comprise (e.g., indicate) a co-dependent flows timestamp set by the WTRU when sending forward flow packets. The WTRU may compute co-dependent flows round-trip time (RTT) characteristics from the current timestamp value and the indicated co-dependent flows timestamp (e.g., value).

In a second example, the co-dependent flows information may comprise a co-dependent flows mark IE. The WTRU may compute one or more co-dependent flows round-trip time characteristics from measurement of the timestamp before sending the co-dependent flows mark IE in forward flow packets and the timestamp when receiving the co-dependent flows mark IE in a reverse flow packet.

In a second embodiment, the client WTRU application may interact with the network layer to expose any of QoS information and QoS adjustment based on any of (i) a co-dependent flows association, and (ii) co-dependent flows information and adjustment exposure (based on WTRU assistance information and/or in related forward/reverse flow marks and/or through any 5G Core Network API, for example, via NEF (Network Exposure Function) or PCF (Policy Control Function).

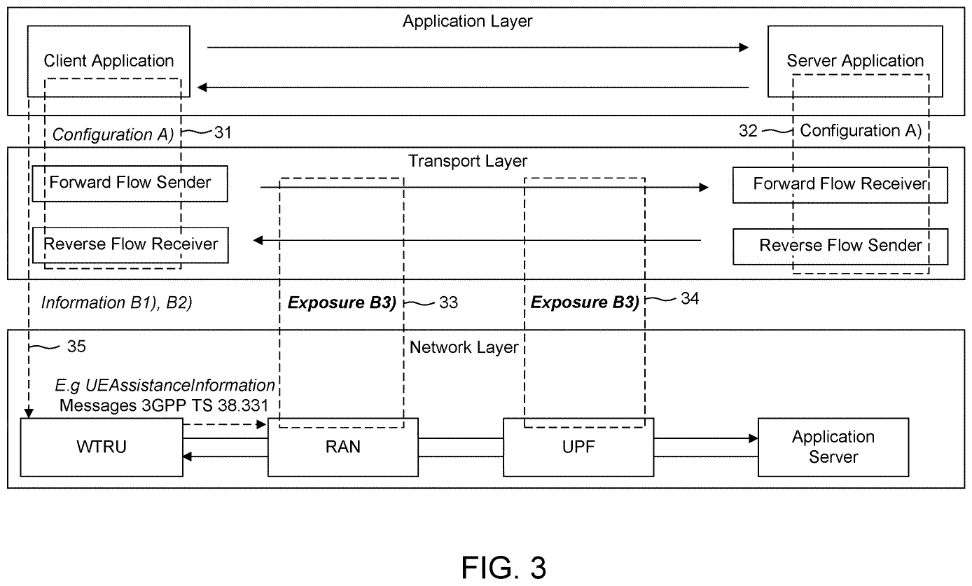

FIG. 3 is a diagram illustrating an example of QoS flow information carried in transport layers. In an example, a client application and a server application may configure the transport layer to A) enable QoS measurements 31, 32 and to B3) expose adjustments 33, 34 to the network layer. The client application may directly provide information 35 to the WTRU for B1) flows dependency association or B2) (e.g., as an alternative) to expose adjustments. In an example, the WTRU may forward information to the RAN using, for example, a UEAssistanceInformation message as described in 3GPP TS 38.331, “NR; Radio Resource Control (RRC); Protocol specification (V17.0.0). In another example, (not represented in FIG. 3), for exposing adjustment information, the WTRU may forward adjustment information to the core network based on core network message, for example, via any of a NEF and a PCF API message.

In a 3GPP network embodiment, the WTRU may interact with a RAN base station to access the core network (CN). The WTRU may transmit forward flow packets in the uplink via the RAN, and via the UPF in the CN to the application server. The application server may transmit reverse flow packets in the downlink via the UPF, and via the RAN to the WTRU. For this embodiment, the WTRU may expose co-dependent flows information and/or adjustments in the forward flow to the RAN or, to a 3GPP CN via the RAN or in the reverse flow to the 3GPP CN via the UPF or to the RAN via the 3GPP CN as described in Table 1 and Table 2.

In a Wireless LAN network embodiment, the WTRU may interact with a WLAN access point to access any of a 3GPP access network and a non 3GPP access network. The WTRU may transmit/receive forward/reverse flow packets via or from a WLAN access point. For this embodiment, the WTRU may expose QoS/QoE information and/or QoS/QoE adjustment to the WLAN access point or, to a 3GPP CN or non 3GPP network via a 3GPP access network or, via a non 3GPP access network.

Any of a UPF, a non-3GPP access network and any network element interconnecting the WTRU, and the application server may be configured to receive reverse flow marks from the application server for applying QoS/QoE adjustment rules.

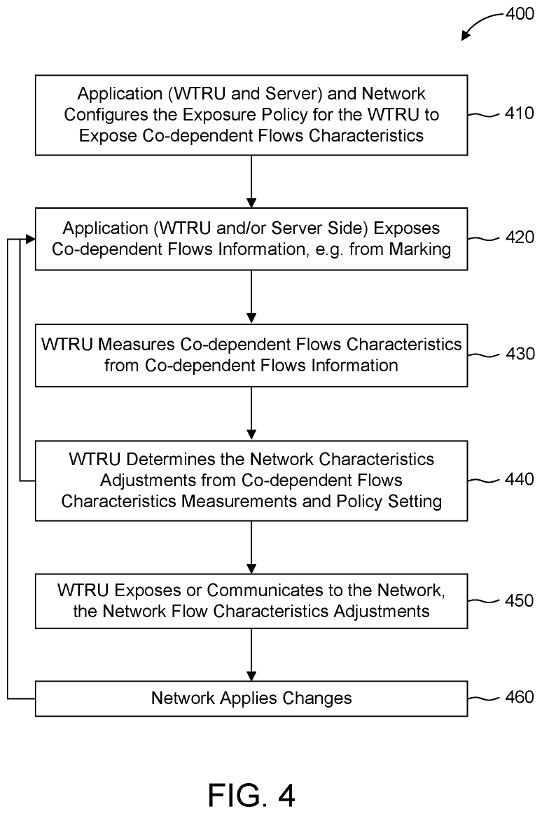

FIG. 4 is a diagram illustrating an example method 400 for measuring and adjusting co-dependent flows characteristics.

As shown at 410, any of the WTRU application, the server-side application and the network may configure the exposure policy for the WTRU to expose co-dependent flows characteristics.

As shown at 420, any of the WTRU application and the server-side application may expose co-dependent flows information, e.g., based on (e.g., inserting) marking information.

As shown at 430, the WTRU may measure co-dependent flows characteristics from co-dependent flows information.

As shown at 440, the WTRU may determine the network characteristics adjustments from any of co-dependent flows characteristics measurements and policy settings.

As shown at 450, the WTRU may expose or communicate to the network, the network characteristics adjustments.

As shown at 460, the network may apply changes.

Embodiments described herein may be applicable to transport protocols capable of a round-trip communication including a co-dependent forward and reverse flow. The application layer may interact with the network layer to measure real time network characteristics variations and to adjust network characteristics with respect to the allocated network resources based on the measured real time network characteristics variations. Embodiments described herein may allow to improve the quality of service based on real time resource adjustment to reduce the loss of packet. Embodiments described herein may allow the application to provide means for the network layer to detect unused resources that may be reallocated to other applications or deallocated, for example, to save energy.

### Overview of QoE Characteristics for Measurement and Adjustment

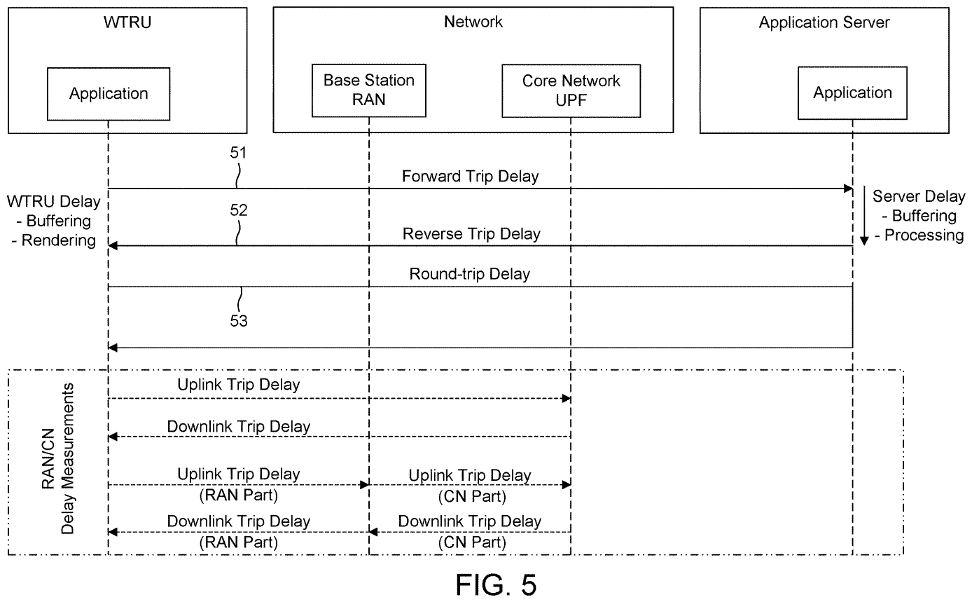

FIG. 5 is a diagram illustrating an example of different QoS/QoE characteristics for measurement and adjustment. Embodiments described herein may allow a WTRU to measure QoS/QoE characteristics illustrated in straight line in real time and estimate the delay to meet its round-trip QoS expectation or to provide an expected QoE experience. For example, the WTRU may measure any of a forward trip time 51, a reverse trip time 52 and a round-trip time 53.

RAN and/or CN may measure characteristics illustrated in dotted lines, such as e.g., any of an uplink trip delay, a downlink trip delay, a RAN part of the uplink trip delay and a CN mart of the uplink trip delay. For example, the WTRU may communicate with the RAN to set (e.g., adjust) UL/DL delay budget for independent flows or the WTRU may request adjustment on UL/DL delays to meet its application QoE.

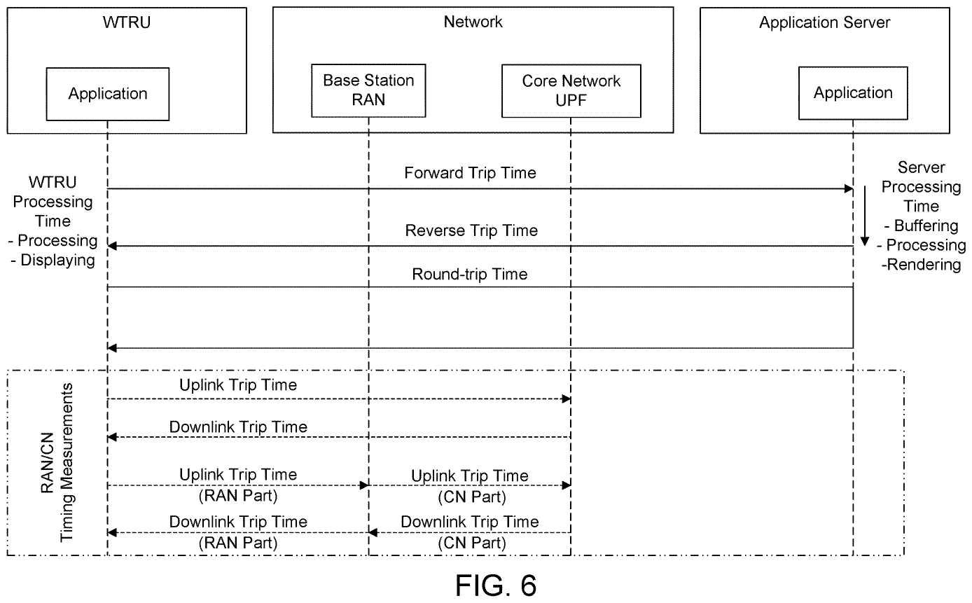

FIG. 6 is a diagram illustrating an example of different timings measurements for QoS/QoE characteristics measurements.

Embodiments are described herein with packet delays (forward trip delay, reverse trip delay, round trip delay), as examples of the co-dependent flow characteristics, where the packet delay refers to a delay between the transmission of the packet and the reception of the packet. Embodiments described herein may be applicable to any other types of delays, such as, for example, packet delay variations, inter packet delays and inter-packet delay variations.

Throughout embodiments described herein the expression “forward/reverse/round trip time” and “forward/reverse/round trip delay” may be used interchangeably to designate a duration of a forward/reverse/round trip of a packet.

Table 1 first column describes the different co-dependent flows timestamps. Table 1 second column describes how the different co-dependent flows timestamps may be used for the measurement of the related co-dependent flows times (e.g., delays). Table 1 third column describes which entity may insert co-dependent flows information (e.g., any of timestamp, time) and Table 1 fourth column describes which entity may read co-dependent flows information (e.g., any of timestamp and time). Table 1 fifth column describes the operations performed by the WTRU and the server to provide co-dependent flows times (e.g., delays).

TABLE 1
co-dependent flows information timestamps and timing measurements

| Co-dependent | | | | |
|---|---|---|---|---|
| flows | Co-dependent | | | |
| timestamps | flows timing | Source | Client | Operations |
| Round-trip | Round-trip time | WTRU | WTRU | Round-trip timestamp |
| timestamp | | | via | insertion in WTRU |
| | | | server | Timestamp replication in |
| | | | | server |
| | | | | Round-trip time |
| | | | | calculation in WTRU |
| Forward trip | Forward trip | WTRU | WTRU | Forward trip timestamp |
| timestamp | time | | via | insertion in WTRU |
| | | | Server | Forward trip time |
| | | | | calculation in Server |
| | | | | Forward trip time insertion |
| | | | | in Server |
| | | | | Forward trip read in |
| | | | | WTRU |
| Reverse trip | Reverse trip | Server | WTRU | Reverse trip timestamp |
| timestamp | time | | | server insertion |
| | | | | Reverse trip calculation in |
| | | | | WTRU |
| Round-trip, | Server | WTRU | WTRU | From marking and |
| forward trip, | processing time | and | | calculation above: |
| reverse trip | | server | | Server processing time |
| timestamp | | | | calculation in WTRU from |
| | | | | round-trip time and |
| | | | | reverse trip time |
| | | | | calculation in WTRU and |
| | | | | forward trip time read |
| | | | | from Server. |
| Round-trip, | Server | WTRU | Server | Server processing time |
| forward trip, | processing time | | | insertion in WTRU |
| reverse trip | | | | Server processing time |
| timestamp | | | | read in server |

Table 2 first column describes the relation between co-dependent flows times (e.g., delays) as described in Table 1 second column. Table 2 second column describes the related co-dependent flows information/characteristics according to delays shown in FIG. 5. Table 2 third column describes the source of the information, e.g., describing which entity (WTRU and/or server) may expose the co-dependent flows information, for example, based on marking transport packets, which may be visible to underlying network layers. Table 2 fourth column describes the client (e.g., destination) receiving the co-dependent flows information and Table 2 fifth column describes the operations between the source and the client to expose co-dependent flows information.

TABLE 2
Co-dependent flows information exposure to the network

| | Co-dependent | | | |
|---|---|---|---|---|
| | flows | | | |
| Co-dependent | information/ | | | |
| flows | Characteristics | | | |
| information | exposure | Source | Client | Operation mode |
| Round-trip | Round-trip | WTRU | RAN/ | WTRU and/or network may |
| time | time | | CN | configure round-trip time |
| | | | | exposure in uplink. |
| | | | | WTRU may expose round-trip |
| | | | | time in uplink |
| | | | | RAN/CN may calculate round- |
| | | | | trip delays and/or budget |
| | | | | variations from an expected |
| | | | | round-trip delay budget. |
| | | | | RAN/CN may determine |
| | | | | adjustment on uplink/downlink |
| | | | | delay (RAN/CN part) |
| Round-trip | Round-trip | WTRU | RAN/ | WTRU and/or network may |
| time | delay | | CN | configure a round-trip delay |
| | adjustment or | | | budget. |
| | round-trip | | | WTRU and/or Network may |
| | delay budget | | | configure any of round-trip |
| | variation | | | delay adjustment and budget |
| | | | | variation exposure in uplink. |
| | | | | WTRU may calculate and |
| | | | | expose the round-trip delay |
| | | | | adjustment (delay |
| | | | | increment/decrement) and/or the |
| | | | | round-trip delay budget variation |
| | | | | (positive/negative variation from |
| | | | | an expected round-trip delay |
| | | | | budget) |
| | | | | RAN/CN may determine |
| | | | | adjustments on uplink and/or |
| | | | | downlink delay (RAN/CN part) |
| | | | | to apply from exposed |
| | | | | information on uplink |
| Round-trip | Round-trip | WTRU | UPF | WTRU and/or network may |
| time | delay | via | | configure a round-trip delay |
| | adjustment or | server | | budget. |
| | round-trip | | | WTRU and/or network may |
| | delay budget | | | configure round-trip delay |
| | variation | | | adjustment and/or budget |
| | | | | variation exposure in a reverse |
| | | | | flow. |
| | | | | WTRU may measure the round- |
| | | | | trip delay. Adjustment and/or |
| | | | | budget variation as above. |
| | | | | WTRU may communicate the |
| | | | | round-trip delay adjustment |
| | | | | and/or budget variation to the |
| | | | | server. |
| | | | | Server may expose round-trip |
| | | | | delay adjustment and/or budget |
| | | | | variation in downlink to the |
| | | | | network (UPF), for example, by |
| | | | | inserting marks in the reverse |
| | | | | flow. |
| | | | | Network (CN or RAN) via UPF |
| | | | | may determine adjustment on |
| | | | | uplink and/or downlink delays |
| | | | | (RAN/CN part) to apply from |
| | | | | exposed information on |
| | | | | downlink |
| Forward trip | Forward trip | WTRU | RAN/ | WTRU and/or network may |
| time | time | | CN | configure forward trip time |
| | | | | exposure in uplink. |
| | | | | WTRU may expose forward trip |
| | | | | time to network (RAN/CN) in |
| | | | | uplink. |
| | | | | RAN/CN may calculate and |
| | | | | determine adjustment on uplink |
| | | | | and/or downlink delay |
| | | | | (RAN/CN part) |
| Forward trip | Forward trip | WTRU | RAN/ | WTRU and/or network may |
| time | delay | | CN | configure forward trip delay |
| | adjustment or | | | budget. |
| | forward trip | | | WTRU and/or network may |
| | delay budget | | | configure forward trip delay |
| | variation | | | adjustment and/or budget |
| | | | | variation exposure in uplink. |
| | | | | WTRU may calculate and |
| | | | | expose the forward trip delay |
| | | | | adjustment (delay |
| | | | | increment/decrement) and/or the |
| | | | | forward trip delay budget |
| | | | | variation (positive/negative |
| | | | | variation from an expected |
| | | | | forward trip delay budget). |
| | | | | RAN/CN may determine |
| | | | | adjustments on uplink and/or |
| | | | | downlink delays (RAN/CN part) |
| | | | | to apply from exposed |
| | | | | information. |
| Reverse trip | Reverse trip | WTRU | RAN/ | WTRU and/or network may |
| time | time | | CN | configure reverse trip time |
| | | | | exposure in uplink. |
| | | | | WTRU may expose reverse trip |
| | | | | time to network (RAN/CN) in |
| | | | | uplink. |
| | | | | RAN/CN may calculate and |
| | | | | determine adjustment on |
| | | | | uplink/downlink delay |
| | | | | (RAN/CN part). |
| Reverse trip | Reverse trip | WTRU | UPF | WTRU and/or network may |
| time | time | via | | configure reverse trip time |
| | | server | | marks exposure in a reverse |
| | | | | flow. |
| | | | | WTRU may communicate the |
| | | | | reverse trip time to the server. |
| | | | | Server may expose the reverse |
| | | | | trip time in downlink to network |
| | | | | (UPF), for example, by inserting |
| | | | | marks in the reverse flow. |
| | | | | Network (CN or RAN) via UPF |
| | | | | may calculate and determine |
| | | | | adjustment on uplink and/or |
| | | | | downlink delay (RAN/CN part). |
| Reverse trip | Reverse trip | WTRU | RAN/ | WTRU and/or network may |
| time | delay | | CN | configure a reverse-trip delay |
| | adjustment or | | | budget. |
| | reverse trip | | | WTRU and/or network may |
| | delay budget | | | configure reverse trip delay |
| | variation | | | adjustment and/or budget |
| | | | | variation exposure in uplink. |
| | | | | WTRU may calculate and |
| | | | | expose the reverse trip delay |
| | | | | adjustment (delay |
| | | | | increment/decrement) and/or the |
| | | | | reverse trip delay budget |
| | | | | variation (positive/negative |
| | | | | variation from an expected |
| | | | | reverse trip delay budget). |
| | | | | RAN/CN may determine |
| | | | | adjustments on uplink and/or |
| | | | | downlink delays (RAN/CN part) |
| | | | | to apply from exposed |
| | | | | information. |
| Reverse trip | Reverse trip | WTRU | UPF | WTRU and/or network may |
| time | delay | via | | configure a reverse trip delay |
| | adjustment or | server | | budget. |
| | reverse trip | | | WTRU and/or network may |
| | delay budget | | | configure reverse trip delay |
| | variation | | | adjustment and/or budget |
| | | | | variation exposure in a reverse |
| | | | | flow. |
| | | | | WTRU may measure the reverse |
| | | | | trip delay adjustment and/or |
| | | | | budget variation as above. |
| | | | | WTRU may communicate the |
| | | | | reverse trip delay adjustment |
| | | | | and/or budget variation to the |
| | | | | server. |
| | | | | Server may expose reverse trip |
| | | | | delay adjustment and/or budget |
| | | | | variation in downlink to the |
| | | | | network (UPF), for example, by |
| | | | | inserting marks in the reverse |
| | | | | flow. |
| | | | | Network (CN or RAN) via UPF |
| | | | | may determine adjustment on |
| | | | | uplink and/or downlink delays |
| | | | | (RAN/CN part) to apply from |
| | | | | exposed information on |
| | | | | downlink |
| Server | Server | WTRU | Server | WTRU and server may |
| processing | processing | | | configure the means for the |
| time | time | | | WTRU to expose the server |
| | | | | processing time. |
| | | | | WTRU and the server may |
| | | | | determine the processing time |
| | | | | budget to apply. |
| | | | | WTRU may expose the server |
| | | | | processing time to the server. |
| | | | | The server may determine the |
| | | | | server processing time delay |
| Server | Server | WTRU | Server | WTRU and server may |
| processing | processing | | | configure the means for the |
| time | time delay or | | | WTRU to expose the server |
| | service | | | processing delay/delay |
| | processing | | | deviation. |
| | time delay | | | WTRU and server may |
| | deviation | | | determine the processing delay |
| | | | | budget to apply. |
| | | | | WTRU may expose the server |
| | | | | processing delay to the server. |
| | | | | The server may adjust |
| | | | | (increment/decrement) the |
| | | | | processing time by means of |
| | | | | adapting processing tasks of the |
| | | | | server processing pipeline. |

Example of a WTRU Determining the Co-Dependent Round-Trip Flows Characteristics (e.g., Metrics) Based on Receiving Information Replicated in a Reverse Flow from a Forward Flow

The WTRU may determine one or more co-dependent flows round-trip characteristic(s) based on sending and receiving co-dependent flows information.

In one embodiment, co-dependent flows information may comprise (e.g., indicate) a co-dependent flows round-trip timestamp, which may be sent by the WTRU in the forward flow, and which may be replicated by the server in the reverse flow. The co-dependent flows round-trip timestamp may be referred to herein as forward timestamp. The WTRU may receive the forward timestamp being sent and replicated by the server and, may determine the co-dependent round-trip time (RTT) from the time elapsed between the reception of the forward timestamp and the current timestamp value. This embodiment may be referred to as stateless, based on the WTRU not saving data.

In another embodiment, co-dependent flows information may comprise (e.g., indicate) co-dependent flows mark IE, to be used as an identifier (e.g., marker) of the packet including the co-dependent flows mark. The WTRU may determine (e.g., compute) the co-dependent flow round-trip time characteristics based on measuring (e.g., logging) the time (e.g., timestamp) before sending the co-dependent flows mark IE in a forward flow packet and the time (e.g., timestamp) when receiving co-dependent flows mark IE in a reverse flow packet. The mark (e.g., in the flows mark IE) may comprise any (e.g., random) value known and shared between the WTRU and the server, for example, at setup stage. The WTRU may keep (e.g., store) the original timestamp value associated to the mark being sent. This embodiment may be referred to as stateful based on the WTRU saving data (e.g., between sending a packet in a forward flow and receiving the corresponding packet in the reverse flow).

In another embodiment, the co-dependent flows information may comprise one or more different timestamps as described in Table 1 depending on the delays the WTRU may calculate as described herein.

In a first example, the WTRU may set and insert a forward flow timestamp, or the same round-trip timestamp as described above. The reception of the forward flow timestamp, for example, from receiving a co-dependent flows information indicating a WTRU request for forward flow timestamp from the WTRU may trigger the server to process the request. The co-dependent flows information in the forward flow may comprise a “co-dependent flows” forward flow timestamps IE mark. The server may determine (e.g., calculate) the forward flow delay from the (e.g., current) server time minus the forward flow timestamp value. The server may send a packet comprising information indicating the forward flow delay, for example, inserted in a dedicated field of a packet in the co-dependent reverse flow. The delay may be a “co-dependent flows” forward flow delay IE mark in the reverse flow.

In a second example, the WTRU may send information indicating a request for a reverse flow timestamp to the server. The information may comprise (e.g., indicate) a “co-dependent flows” reverse flow timestamp request IE to the server. The reception of the “co-dependent flows” reverse flow timestamp request IE may trigger the server to insert information indicating a reverse timestamp value in a packet of the reverse flow. The server may insert a “co-dependent flows” reverse flow timestamp IE mark in the reverse flow belonging to co-dependent flows. Based on the reception of the “co-dependent flows” reverse flow timestamp IE mark, the WTRU may determine (e.g., calculate) the reverse flow delay from the current WTRU time minus the received reverse timestamp value.

In an embodiment, the different delay calculation described herein may allow the WTRU to determine (e.g., calculate) the server delay part (e.g., contribution) as illustrated in FIG. 5. In an example, the WTRU may send to the server information indicating the server delay contribution part regarding the co-dependent flows round-trip delay. The WTRU may send a server delay IE mark in the forward flow to carry the server delay value to the server.

In an embodiment, the WTRU may determine the frequency to obtain (e.g., compute) co-dependent flows round-trip characteristics. The WTRU may send or update a co-dependent flows frequency IE to the server (e.g., indicating a value of a co-dependent flows frequency). The server may use the frequency value to trigger the reception of any other co-dependent flows information described herein.

In an embodiment, the WTRU and the server application may configure the policy to communicate co-dependent flows information to the other side. Co-dependent flows information may be provided based on any of a (e.g., regular) sampling frequency basis, applicative data information, and (e.g., specific) header type or information in a received flow packet (any of forward and reverse flow).

In an embodiment, the co-dependent flows information may comprise packet numbering (e.g., counting) information, including e.g., packet counting/numbering continuation from the forward flow and the reverse flow to allow the network to calculate co-dependent flows timings described in Table 1.

In an embodiment, the co-dependent flows information may comprise a co-dependent flows mark IE value encoded e.g., with an algorithm. Examples may include transition patterns from “0” to “1” or “1” to “0” spin bit value. The sender may change the pattern or toggles the spin bit value after a (e.g., each) round-trip.

### Example of Using RTP/RTCP Co-Dependent Flows Timestamp Mark for Co-Dependent Round-Trip Delay Measurement

An example implementation is described herein based on receiving a timestamp in an RTP header of a reverse flow that may be a copy or a replication of a timestamp that may have been sent in an RTP header in a forward flow.

For example, round-trip QoS/QoE may be measured (e.g., determined) based on inserting QoE information in one or more RTP frames of a stream. QoS/QoE information may not be inserted in each RTP frame of the stream.

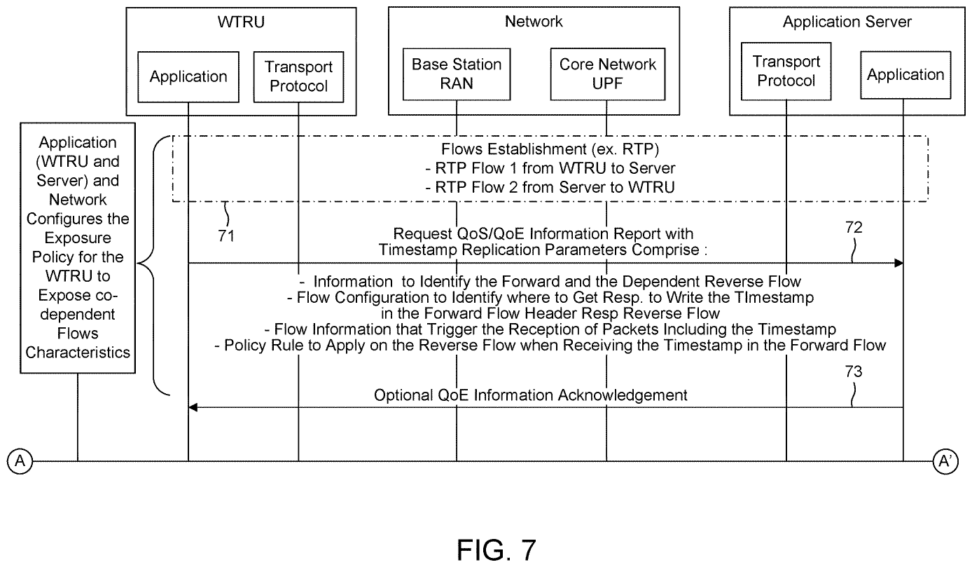

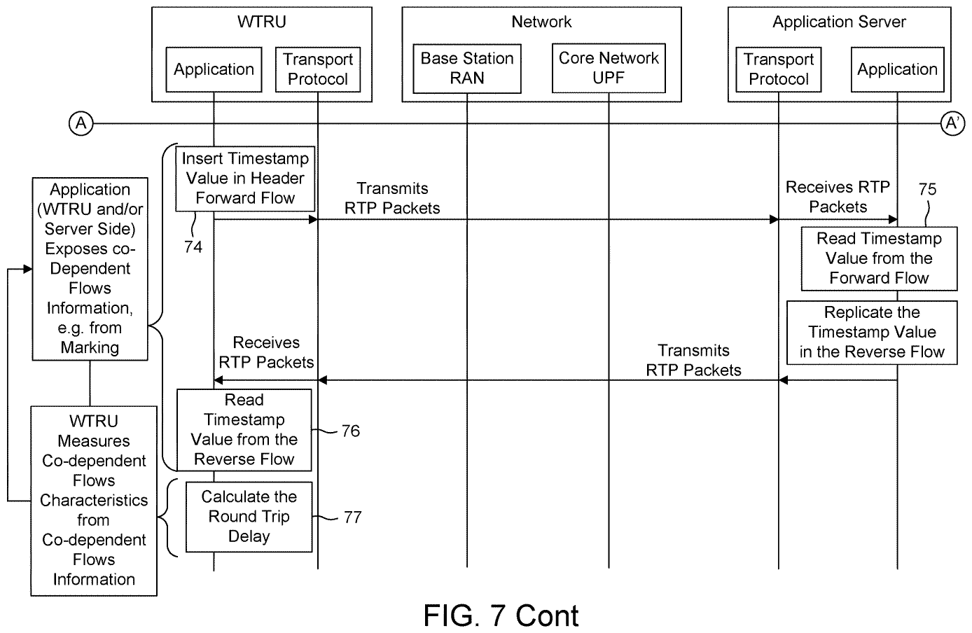

FIG. 7 is a diagram illustrating an example method for delay measurement based on any of real time protocol (RTP) and real time control protocol (RTCP) mark timestamps.

### Configuration Phase

As shown at 71, the application running between the WTRU and the server may establish two co-dependent flows, such as e.g., a first (e.g., forward) flow (e.g., based on RTP for carrying pose information from the WTRU to the application server), and a second (e.g., reverse) flow (e.g., based on RTP for carrying XR rendering video from the application server to the WTRU).

As shown at 72, the WTRU (e.g., application) may send request information to the application server indicating a request to enforce (e.g., perform) a timestamp replication policy (e.g., rule), a policy (e.g., rule) including means to identify the dependent flow timestamp IE in a forward flow, when and where to obtain the timestamp in the forward flow and where to replicate the value of the dependent flow timestamp IE in the reverse flow. The request information may comprise one or more parameters indicating any of one or more first forward flow parameters, one or more second forward flow parameters, and one or more action rule parameters.

The one or more first forward flow parameters may indicate any of a RTP payload type and a RTP header extension type including a co-dependent flows timestamp IE field containing the current timestamp value e.g., measured by the WTRU before (e.g., when) sending the forward flow packets (e.g., indicating the time at which the RTP packet has been transmitted in the forward flow). For example, the one or more first parameters may comprise a first (e.g., forward) flow identifier.

The one or more second reverse flow parameters may indicate any of a RTP payload type and a RTP header extension type including a co-dependent flows timestamp IE field (e.g., to be used) for inserting the previous (e.g., replicated) timestamp value. For example, the one or more second parameters may comprise a second (e.g., reverse) flow identifier.

The one or more action rule parameters may indicate an action rule for instructing the reverse RTP transport layer (e.g., in the application server) in replicating the timestamp according to any of the following examples.

In a first example, an action rule parameter may indicate mirroring the received timestamp value of the forward flow to (e.g., all) the RTP packets of the reverse flow. For example, a hook may be created between received timestamp memory and the transmit timestamp memory.

In a second example, an action rule parameter may indicate sending back the timestamp in one or more first RTP packet(s) of the corresponding dependent second flow. For example, the first (e.g., initial) RTP packets of the new rendered pose stream.

In a third example, an action rule parameter may indicate sending back the timestamp in (e.g., all) the RTP packet(s) of the corresponding dependent second flow, for example, all the packets of the new rendered pose stream.

In a fourth example, an action rule parameter may indicate sending back the timestamp in a number X of RTP packets after a new timestamp may have been received. X may be an integer number, configured (e.g., shared) between the WTRU and the server.

As shown at 73, the application server may send acknowledge information for acknowledging the request information to the WTRU from which co-dependent flows timestamp IE may be received. For example, the application server may apply the policy rule in the reverse flow.

### Measurement Phase

As shown at 74, the WTRU may determine (e.g., any of compute, and get) the current timestamp value from the system and, for example, may write (e.g., insert) the timestamp value in the co-dependent flows timestamp IE of the RTP/RTCP header of a packet of the forward flow. For example, the WTRU may insert information (such as e.g., a specific header type value within the header) indicating that any of timestamp information and co-dependent flows mark IE may be sent, e.g., for triggering server action.

As shown at 75, the reception of any of co-dependent flows timestamp information, a (e.g., specific) RTP header type, and a (e.g., specific) co-dependent flows mark IE may trigger the application server to read the timestamp value from the co-dependent flows timestamp IE field of the RTP header of the received forward flow and may enforce (e.g., activate) the corresponding policy rule established with (e.g., indicated, requested by) the WTRU, such as, for example, (i) replicating the timestamp value in the co-dependent flows timestamp IE field of the RTP header in the reverse flow, (ii) updating the RTP header type (e.g., if appropriate), and (iii) transmitting packets in the reverse flow.

As shown at 76, the reception of any of a co-dependent flows timestamp IE, a (e.g., specific) RTP header type, and a (e.g., specific) co-dependent flows mark IE may trigger the WTRU to read the timestamp value from the co-dependent flows timestamp IE field of the RTP header of the reverse flow.

As shown at 77, the WTRU may determine any of the round-trip delay and the round-trip delay variation based on calculating the current and previous round-trip time based on comparing current and previous received co-dependent flows timestamps.

In an embodiment, RTCP message exchange between the WTRU to the application server may be used for providing the round-trip QoS/QoE metrics to the WTRU. RTCP messages may be sent asynchronously where RTP information may be sent synchronously (with the content information). RTCP may be referred to as a control protocol providing QoS metric for RTP. RTCP messages may be sent less frequently than RTP packets to reduce the number of control packets.

### Example of Exposing the Service Flows Dependency to the Network by the WTRU

In an embodiment, the application may interact with network layer to expose to the network (RAN/CN) the dependencies between the different flows belonging to an application. For example, the application may share information between the WTRU and the server to identify the co-dependent flows. Sharing information related to the dependencies between different flows of an application may be performed when establishing the application streams such as, for example, any of RTCP, RTP, QUIC and TCP streams in any of forward and reverse direction.

In an embodiment, the application may create association information such as e.g., a co-dependent flows identifier, indicating that the co-dependent flows may be associated (e.g., dependent). The association information (e.g., co-dependent flows identifier) may be passed (e.g., exposed) to the network with information of a (e.g., each) flow identified as co-dependent (such as e.g., a forward and a reverse flow as described herein). The co-dependent flows identifier may comprise, for example, a multi modal service identifier (Multi-Modal Service ID).

In an embodiment, the application may expose to the network information of a (e.g., each) flow identified as co-dependent (such as e.g., a forward and a reverse flow as described herein). The network may create and keep a co-dependent flows information identifier associating the dependent flow information and may return (e.g., send information indicating) the co-dependent flows identifier back to the application. The application exposing the information to the network may be a WTRU application, which may invoke any of a PCF and a NEF API. The application exposing the information to the network may be server-side application that may invoke any of a PCF and a NEF API.

In an example, the application may expose the co-dependent flows identifier for further network configuration, in a same information exposure as when exposing co-dependent flows measurements and/or co-dependent flows adjustments of co-dependent flows information (e.g., characteristics) according to Table 1 and/or Table 2. For example, any co-dependent flow information according to any of Table 1 and 2 may be exposed (e.g., transmitted) to the network (e.g., CN/RAN) and/or the application server. For example, the co-dependent flows identifier may be used by the network to retrieve the corresponding co-dependent flows information. For example, the network may notify the application with (e.g., send information indicating) the co-dependent flows identifier, in a case where the network updates a configuration, for example, when the network may update a delay budget related to at least a part of the co-dependent flows.

In an embodiment, the WTRU (e.g., application) may obtain QoS flow identifiers belonging to the same or to different PDU sessions and may transmit information indicating the corresponding dependent QoS flow identifiers to the network (CN/RAN) with, for example, additional dependence (e.g., association) information. Transmission to the network may be performed by sending the information to, for example, an application server which may then invoke any of an NEF and a PCF API to send the information to the network.

In an embodiment, the network may create and keep a co-dependent flows information identifier associating the dependent QoS flow identifiers with the additional dependence information and, may return the dependent flows identifier back to the WTRU (e.g., application). The WTRU (e.g., application) may pass (e.g., transmit) these dependent flows identifier for further configuration of the QoE/QoS dependence.

In an embodiment, additional dependence information may include global or different QoS rules co-dependent characteristics according to any of the following examples.

In a first example, additional dependence information may indicate a direction of the dependence (for example forward/uplink for the first flow and reverse/downlink for the second.) The application between the WTRU and the server may know and share co-dependent flows information to identify the forward and the reverse flow according to any embodiments described herein.

In a second example, additional dependence information may indicate a QoS flow rule and associated QoS flow rule identifier (QFI). As described herein, the application may interact with the network to expose co-dependent flows information, including for example determining the mapping of QoS flow rule including QFI to the co-dependent flows in the forward or in the reverse direction.

In a third example, additional dependence information may indicate a configuration of packet set filters for identifying a packet flow. As described herein, the application may interact with the network to determine the packet filters used to detect uplink and/or downlink co-dependent flows. For example, in an RTP embodiment, the packet filter may comprise five tuples including RTP protocol information.

In a fourth example, additional dependence information may indicate one or more co-dependent round-trip QoS flow parameters including any of guaranteed, maximum, range (min, max) bitrates associated with the forward and/or reverse flow to meet one or more expected latencies (e.g., delays). For example, considering a latency of twenty milliseconds for uplink and thirty milliseconds for downlink, the round-trip may be set to fifty milliseconds. The application may have a latency expectation, for example, to not exceed a motion to photon timing for XR application to enable an acceptable QoE for the end user. The application QoS expectations may drive the co-dependent round-trip QoS flow parameters to be configured with the network.

Example of a WTRU Configuring a Policy with the Network to Expose Co-Dependent Flows Information

In an embodiment, the WTRU and/or the network may any of configure, establish, and agree to expose co-dependent flows information (e.g., characteristics) described herein, for example, including any of a round-trip time, a round-trip delay adjustment, a round-trip delay budget variation, a forward trip time, a forward trip delay adjustment, a forward trip delay budget variation, a reverse trip time, a reverse trip delay adjustment, and a reverse trip delay budget variation according to Table 2.

Exposure of co-dependent flows information (e.g., characteristics) to the network (RAN/CN/UPF) may be used to adjust any of an uplink/forward trip delay (RAN part, CN part), a downlink/reverse trip delay (RAN part, CN part), and a round-trip delay that may include forward uplink and the reverse downlink enabling the network (RAN/CN/UPF) to determine and select the adjustment in the uplink, the downlink or both flows at a time to meet a target round-trip delay.

In an embodiment, the WTRU and/or the network may any of configure, establish and agree on exposing a delay budget for one or more measured co-dependent flows delays (UL/DL/round-trip), including any of the following examples.

In a first example, a delay budget may comprise any of an expected standard delay and an expected median delay budget.

In a second example, a delay budget may comprise one or more delay budget range (min, median, max).

In a third example, a delay budget may comprise one or more delay budget thresholds to trigger sending a message (critical lower limit, critical upper limit).

In a fourth example, a delay budget may comprise a communication mode to send assistance information and adjustment such as a periodic mode with e.g., a sampling frequency and/or an aperiodic mode associated with event triggers, e.g., associated with delay budget threshold and current delay values, for example.

In an embodiment, the WTRU and/or the network may any of configure, establish and agree on exposing delay adjustments for one or more measured co-dependent flows delays (UL/DL/round-trip), including any of the following examples.

In a first example, a delay adjustment may indicate a delay adjustment decrease. The application may measure and, anticipate or predict that a measured delay (UL/DL/round-trip) may be to be reduced, for example, to meet the end-to-end latency objective.

In a second example, a delay adjustment may indicate a delay adjustment increase. The application may measure and, anticipate or predict that the delay (UL/DL/round-trip) may be relaxed, for example, to indicate to the network to save bandwidth and/or energy.

In a third example, a delay adjustment may indicate a delay prediction including any of a confidence estimation of the prediction and an expected timing of the prediction. The WTRU application may predict that the delay may increase based on expected forward/reverse flow bandwidth variation and/or based on buffering/processing delay variations.

In a fourth example, a delay adjustment may indicate any of a delay range and a threshold reached (any of lower and upper bound, useless lower limit, critical upper limit)

In an embodiment, the WTRU and/or the network may any of configure, establish and agree on a delay measurement method, for example, based on any of the following measurement method parameters.

In a first example, a delay measurement method parameter may comprise the duration of measurement.

In a second example, a delay measurement method parameter may comprise the type of measurement (e.g., periodic, event triggered).

In a third example, a delay measurement method parameter may comprise the number of times to measure a delay and reporting periodicity. For example, the WTRU may observe that a delay may reach a lower bound limit or an upper bound limit for a duration and/or may measure several times that the delay may reach a limit. This parameter may allow to avoid measurement error or peak variations that the application may cope with for a duration.

In a fourth example a delay measurement method parameter may comprise a measurement statistics mode indicating how the delay measurement may be performed with the corresponding parameters (e.g., any of standard deviation, average, median, maximum).

In an embodiment, the WTRU and/or the network may any of configure, establish and agree on exposing delay budget variation for one or more measured co-dependent flows delay budget variation (uplink/downlink/round-trip) including any of (i) a standard deviation/variation, (ii) an average deviation/variation, (iii), a median deviation/variation, (iv) a minimum and a maximum deviation/variation, and (v) a probability distribution (gaussian, Normal) including a set of probability values.

In an embodiment, the RAN/CN may report to the WTRU the effective adjustment or adjustment feedback that the network may have applied regarding the desired adjustment of the co-dependent flows characteristics exposed by the WTRU. The feedback information may include an indication of where the adjustment may have been done (RAN part/CN Part). The feedback information may include any of an uplink/forward trip time adjusted delay feedback, a downlink/reverse trip time adjusted delay feedback (RAN part/CN Part) and a round-trip delay adjustment as a sum of the forward/uplink and reverse/downlink adjustment.

In an embodiment, the WTRU may send WTRU assistance messages (e.g., as described in clause § 5.7.4 of 3GPP TS 38.331, “NR; Radio Resource Control (RRC); Protocol specification” (V17.0.0)), for exposing co-dependent flows information, characteristics, or adjustments. For example, a WTRU assistance message may comprise any information for identifying the co-dependent flows according to any embodiment described herein.

In an embodiment, the WTRU and/or the network may any of configure, establish, and agree to expose co-dependent flows information (e.g., characteristics) described herein (e.g., including any parameter described in Table 2, second column) by marking (e.g., inserting marking information in) packets in the forward and/or in the reverse flow. The application may write (e.g., insert, include) one or more marks that may be visible for (e.g., accessible to) the network layer (of any network element in charge of processing the forward and/or reverse flow). Examples of packet marking information may include one or more information element in the flows according to any of the following examples.

In a first example, marking information may be associated with a (e.g., specific, updated) protocol header type value, indicating that the packet may include the marking information.

In a second example, marking information may be associated with a (e.g., specific, updated) bit field location where (e.g., specific, updated) bit field values (e.g., of the marking information) may be read.

In a third example, marking information may be associated with a (e.g., new) protocol header extension type, indicating that the packet may include the marking information.

For example, the presence of flow mark information associated with (e.g., indicating) any of a delay adjustment and a budget variation according to any embodiment described herein, may trigger (e.g., indicate a request to) the network to read one or more adjustments delay/variations mark values from the application. For example, the presence of associated co-dependent flows information identifier or information element mark may trigger (e.g., indicate a request to) the network to read one or more adjustments delay/variations mark values from the application.

In an embodiment, any of round-trip, forward trip and reverse trip delay adjustment (and/or budget variations) may be associated with one or more (e.g., different) QoS rules, as described herein.

In a first example, a QoS rule may comprise a QoS flow rule and associated QoS flow rule identifiers (QFI). The application may interact with the network to expose co-dependent flows information, including for example, determining the mapping of QoS flow rule including QFI to the co-dependent flows in the forward and/or reverse direction.

In a second example, a QoS rule may comprise a configuration of packet set filters for identifying packet flow marks. The application may interact with the network to determine one or more packet filters to be used to detect (e.g., determine) uplink and/or downlink co-dependent delay adjustment (e.g., and/or budget variations). The packet filter may include first (e.g., five tuples) information including the protocol information (e.g., RTP) and second (e.g., additional) information to detect (e.g., indicate) delay adjustment (e.g., and/or budget variations) from the application.

In a third example, a QoS rule may comprise one or more co-dependent round-trip QoS flow parameters including any of guaranteed, maximum, range (min, max) bit rates associated with the forward and/or the reverse flow to meet one or more expected round-trip/forward trip/reverse trip delay budget. For example, considering a delay of twenty milliseconds for uplink and thirty milliseconds for downlink, the round-trip delay may be set to fifty milliseconds. The application may have a latency expectation, for example, to not exceed a motion to photon timing for XR application to enable an acceptable QoE for the end user.

### Example of QoE Delay Adjustment Exposure in Forward/Reverse RTP Flow Marks

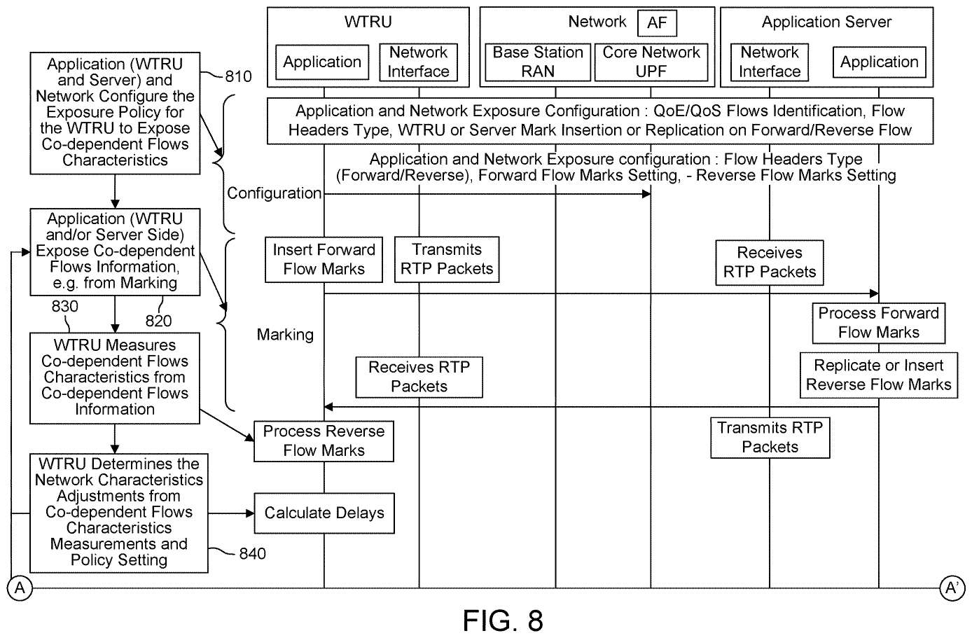

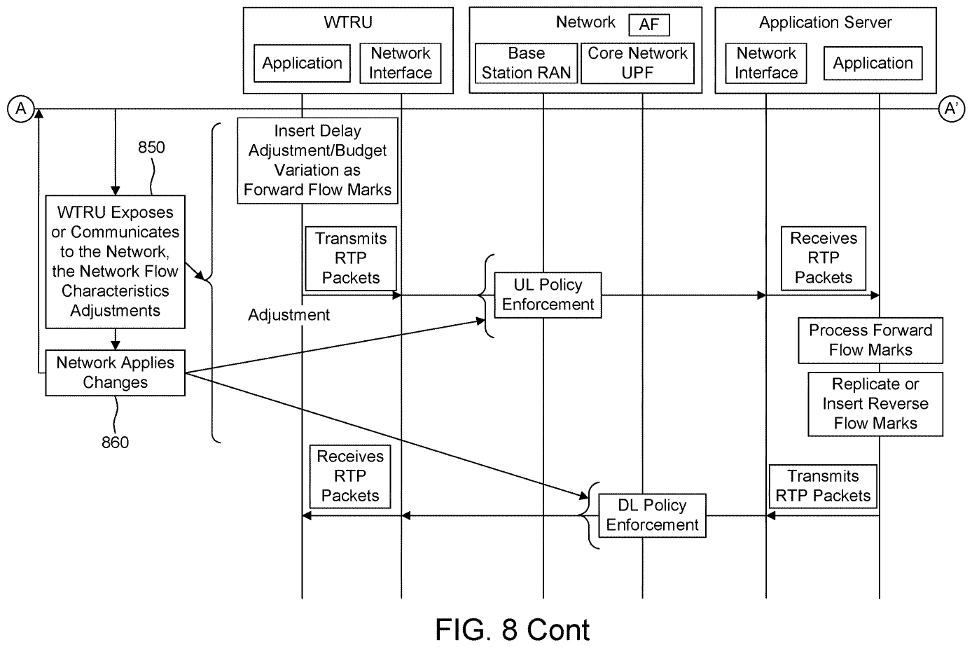

FIG. 8 is a diagram illustrating an example method for QoS/QoE delay adjustment exposure in forward/reverse RTP flow marks. In an example, the WTRU may transmit forward/reverse flow marks to expose flow information and adjustments (as described herein) for the uplink forward flow to the RAN and/or for the downlink reverse flow to the UPF.

As shown at 810 of application and network policy exposure configuration, the WTRU and server application may identify the forward (e.g., uplink flow and the co-dependent reverse (e.g., downlink) flows and may configure the policy for marking the forward and the reverse flows according to any embodiment described herein. The WTRU and the server may be configured to insert and/or replicate selected QoS/QoE information and adjustments.

The WTRU and/or the network may any of configure, establish, and agree to expose co-dependent flows information (e.g., characteristics), for example, for any of (i) detecting (e.g., indicating) a co-dependent flows information or information element mark and detecting (e.g., indicating) delay adjustment/variation marks in the forward flow and/or in the reverse co-dependent flows, according to any of the following examples.

In a first example, the exposed co-dependent flows information may comprise a mark indicating a co-dependent flows identifier. In an RTP example, the mark may include a RTP header type to trigger (e.g., co-dependent flows information identifier).

In a second example, the exposed co-dependent flows information may comprise a forward (e.g., uplink) flow mark. In an RTP example, the forward flow mark may include a RTP header type to trigger any delay adjustment request according to Table 2.

In a third example, the exposed co-dependent flows information may comprise a reverse (e.g., downlink) flow mark. In an RTP example, the reverse flow mark may include a RTP header type to trigger any delay adjustment request according to Table 2.

As shown at 820, the WTRU and/or the server may expose co-dependent flows information (e.g., based on marking information).

As shown at 830 of delay measurement, the WTRU may measure one or more co-dependent flows characteristics (e.g., QoE/QoS delays) according to any embodiment described herein.

As shown at 840 of delay adjustment, the WTRU may determine the delay budget to request (increment/decrement) to the network on the RAN side and/or the CN side for the UPF from the (e.g., applicative) measurements and the policy setting shown at 810.

As shown at 850 of network adjustment marking, the WTRU may insert marking information in packets in the forward flow, wherein the marking information may indicate any of a delay adjustment request and a budget variation request.

In a first example, the marking information may indicate requesting adjusting forward link parameters. For RTP, inserting the marking information may comprise inserting the RTP header type e.g., indicating a forward delay budget adjustment request to the network. For RTP, inserting the marking information may further comprise writing (e.g., inserting) a forward (e.g., uplink) delay adjustment value in any of the corresponding RTP header field and bit fields.

In a second example, the marking information may indicate requesting adjusting reverse link (e.g., downlink) parameters. As described in Table 2, the WTRU may first communicate (e.g., transmit information indicating) any of the delay(s) adjustment and budget(s) variation to the server, for example, by marking (e.g., inserting marking information in packets of the) forward flow for marking adjustment in the reverse flow. The server may replicate the co-dependent flow adjustment received in the forward (e.g., uplink) flow intended to the reverse flow according to any embodiment described herein. For RTP, inserting the marking information may comprise inserting the RTP header type e.g., indicating a reverse delay budget adjustment request). For RTP, inserting the marking information may further comprise writing received forward (e.g., downlink) adjustment value in the corresponding RTP header field and bit fields of the reverse flow.

As shown at 860 of network policy enforcement, any of an uplink policy and a downlink policy may be enforced. For example, for the uplink policy enforcement, the RAN may be triggered by the reception of the forward delay budget request specific header type. The RAN may obtain the requested uplink policy adjustment and may enforce the received requested uplink policy adjustment. For example, for the downlink policy enforcement, the UPF may be triggered by the reception of the reverse delay budget request specific header type. The UPF may obtain the requested downlink policy adjustment and may enforce the received requested downlink policy adjustment.

### Example Method Including Delay Measurements and Adjustments

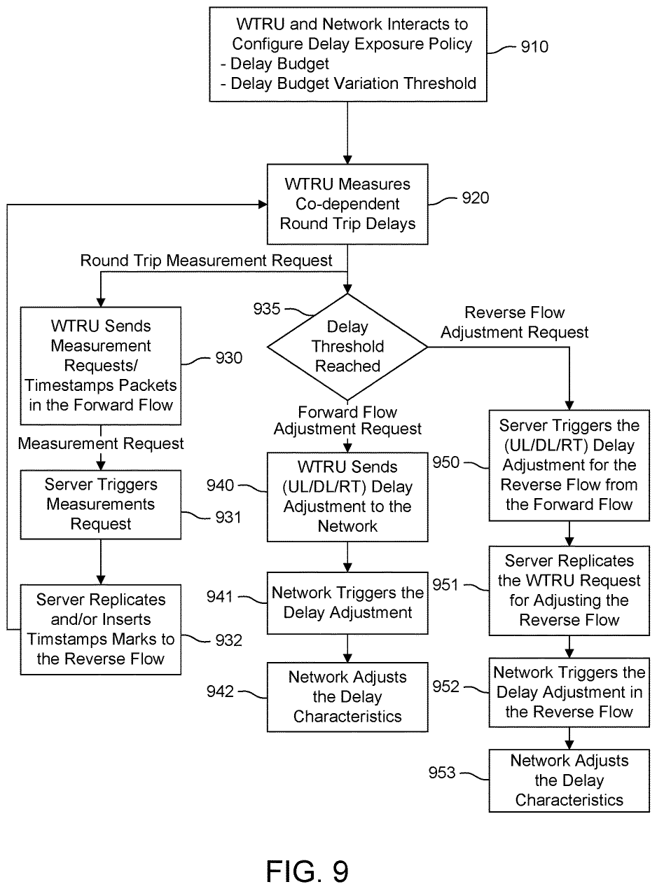

FIG. 9 is a diagram illustrating an example method for delay measurements and adjustments on co-dependent flows. Measurements may be performed based on marking timestamps packets, for example, inside RTP according to any embodiments described herein. Adjustment may be performed by the network based on any of forward and reverse flow marks exposition according to any embodiments described herein.

As shown at 910, the WTRU and the network may interact to configure a delay exposure policy, e.g., including any of a delay budget and a delay budget variation threshold.

As shown at 920, the WTRU may measure one or more co-dependent flows characteristics, such as e.g., round-trip delays.

As shown at 930, the WTRU may send packets in the forward flow including any of measurement request information and time stamp information.

As shown at 931, the server may trigger a measurement request.

As shown at 932, the server may replicate and/or insert timestamp information in the reverse flow.

As shown at 935, it may be determined (e.g., by any of the WTRU and the server) that a measured co-dependent flows characteristics (e.g., a round-trip delay) may fail to meet a QoS (e.g., delay) budget. For example, the measured co-dependent flows characteristics (e.g., round-trip delay) may have reached (and/or be greater than) a threshold.

As shown at 940, the WTRU may send QoS (e.g., delay) adjustment information to the network.

As shown at 941, the network may trigger the QoS (e.g., delay) adjustment.

As shown at 942, the network may adjust the QoS (e.g., delay) characteristic(s).

As shown at 950, the server may trigger QoS (e.g., delay) adjustment for the reverse flow, e.g., based on receiving a request from the forward flow.

As shown at 951, the server may replicate the request (e.g., received from the WTRU) for adjusting the reverse flow.

As shown at 952, the network may trigger (e.g., send adjustment information indicating) the delay adjustment in the reverse flow.

As shown at 953, the network may adjust the QoS (e.g., delay) characteristic(s).

### Example, of QoS/QoE Measurements Triggering Core Network Policy Adjustment Requests

In an example, an application server (such as e.g., an AF network element) may receive a message from a WTRU indicating a round-trip latency measurement. For example, the application server may determine (e.g., calculate) a co-dependent flows round-trip delay measurement based on a message received from the WTRU (e.g., hosted application).

The application server may determine a co-dependent flows round-trip delay measurement. The application server may determine that the total round-trip time may fail to satisfy a delay budget condition (such as e.g., exceeding a tolerable amount of delay), for example, related to a configured delay budget.

In an example, the application server may determine that the co-dependent flows measured round-trip time may not allow to maintain an expected quality of experience or, in contrast may be relaxed e.g., while allowing to maintain an expected quality of experience Based on this determination, the application server may invoke a 5GC API (such as e.g., Nnef_AFsessionWithQOS as described in 3GPP TS 23.501, “System architecture for the 5G System (5GS)” (V18.0.0)) to adjust the (e.g., tolerable) co-dependent flows round-trip delay that may be assumed by (e.g., expected from) the 5GC. For example, in a case where the application server determines that the measured co-dependent flows round-trip delay exceeds a limit by two milliseconds, the application server may invoke the API to indicate to the network that the (e.g., assumed) co-dependent flows round-trip delay may be decreased by two milliseconds. The 5GC may determine how to adjust the packet delay budget on any of the uplink and downlink paths. In another example, in a case where the application server determines that the measured co-dependent flows round-trip delay satisfies a budget condition (e.g., is within a tolerance range and/or below a threshold), the application server may invoke a 5GC API (e.g., Nnef_AFsessionWithQoS) to increase the tolerable co-dependent flows round-trip delay that may be assumed by (e.g., expected from) the 5GC. This may allow the 5G system to have more flexibility in terms of how network resources may be used.

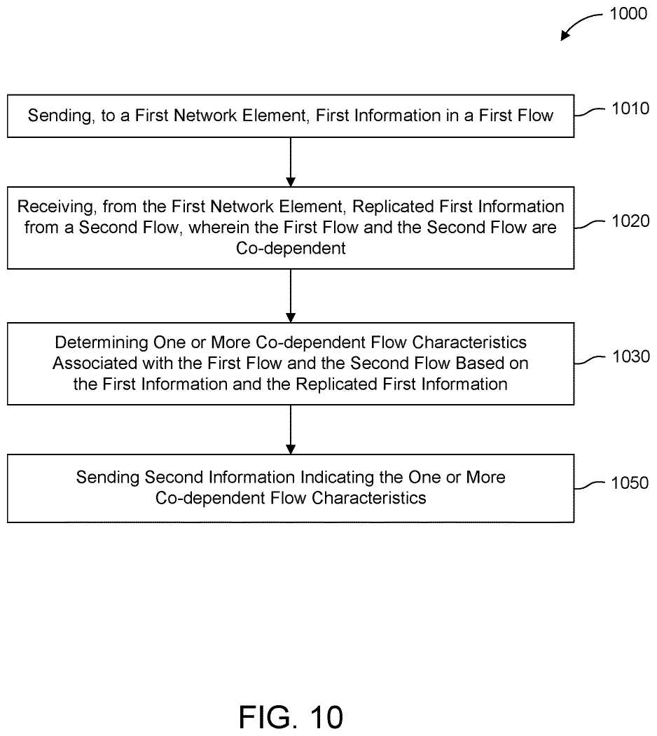

FIG. 10 is a diagram illustrating an example method 1000 for delay measurements and adjustments on co-dependent flows. The method 1000 may be implemented in a WTRU. The WTRU may include circuitry including e.g. any of a processor, a memory, a transmitter and a receiver (e.g., a transceiver) operatively coupled to the processor to perform the method 1000. In an example, the WTRU may send, to a first network element, request information indicating a request to perform a replication policy of information associated with a first flow and a second flow. In various embodiments, the first flow and the second flow may be co-dependent. In an example, the WTRU may receive, from the first network element, acknowledge information for acknowledging the request information. As shown at 1010, the WTRU may send to the first network element, first information in the first flow. As shown at 1020, the WTRU may receive, from the first network element, replicated first information from the second flow. In various embodiments, the first flow and the second flow that may be co-dependent may be associated with an application. As shown at 1030, the WTRU may determine one or more co-dependent flows characteristics associated with the first flow and the second flow based on the first information and the replicated first information. In various embodiments, the WTRU may determine that a co-dependent flows characteristic may satisfy a QoS budget condition e.g., associated with the application. As shown at 1050, the WTRU may send e.g., to a second network element, second information indicating (e.g., associated with) the one or more co-dependent flows characteristics, e.g., based on the determining that a co-dependent flows characteristic may satisfy the QoS budget condition.

In various embodiments the request information may indicate any of one or more first flow parameters, one or more second flow parameters and one or more action rule parameters.

In various embodiments, the first information may comprise timestamp information indicating a time at which a first packet comprising the first information may have been sent.

In various embodiments, the first information may comprise co-dependent flows mark information identifying a first packet in which the first information may have been included.

In various embodiments, the one or more co-dependent flows characteristics may comprise any of a forward trip delay, a reverse trip delay and a round trip delay.

In various embodiments, the second information may be sent to a second network element (e.g., of any of the RAN and the core network) which may be different from the first network element.

In various embodiments, the second network element may be the first network element. In various embodiments, the second information may be inserted in a second packet of the first flow directed to the first network element, wherein the second information may be to be intercepted by a third network element in charge of processing any of the first flow and the second flow between the WTRU and the first network element.

In various embodiments, the second information may comprise association information indicating that the first flow may be associated with the second flow.

In various embodiments, the second information may further indicate the (e.g., determined) one or more co-dependent flows characteristics.

In various embodiments, the second information may further indicate a request for a network policy adjustment associated with any of the first flow and the second flow.

In various embodiments, the WTRU may determine that a co-dependent flows characteristic may satisfy a QoS budget condition.

In various embodiments, the second information may be sent (e.g., to the second network element) based on the co-dependent flows characteristic satisfying the QoS budget condition.

In various embodiments, the requested network policy adjustment may be associated with a first delay adjustment on the first flow.

In various embodiments, the requested network policy adjustment may be associated with a second delay adjustment on the second flow.

In various embodiments, the co-dependent flows characteristic may comprise a delay. In various embodiments, the co-dependent flows characteristic may satisfy the QoS budget condition (e.g., associated with the application) in a case where the delay is above a first threshold. In various embodiments, the requested network policy adjustment may comprise decreasing a latency in any of the first flow and the second flow.

In various embodiments, the co-dependent flows characteristic may comprise a delay. In various embodiments, the co-dependent flows characteristic may satisfy the QoS budget condition (e.g., associated with the application) in a case where the delay is below a second threshold. In various embodiments, the requested network policy adjustment may comprise relaxing (e.g., reducing, decreasing) a latency in any of the first flow and the second flow.

Any characteristic, variant or embodiment described for a method is compatible with an apparatus device comprising means for processing the disclosed method, with a device comprising a processor, a transmitter and a receiver operatively coupled to the processor, configured to process the disclosed method, with a computer program product comprising program code instructions and with a non-transitory computer-readable storage medium storing program instructions.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1. A wireless transmit/receive unit (WTRU) comprising circuitry configured to:
send, to an extended reality (XR) server, request information indicating a request to replicate time information associated with a first flow and a second flow, wherein the first flow and the second flow are co-dependent;
send, to the XR server, first time information in the first flow;
receive, from the XR server, second time information from the second flow, wherein the second time information is a replication of the first time information;
determine a round trip time associated with the first flow and the second flow based on the first time information and the second time information; and
send, to the XR server, report information indicating the round trip time associated with the first flow and the second flow.

2. The WTRU of claim 1, wherein the request information indicates any of one or more first flow parameters, one or more second flow parameters and one or more action rule parameters.

3. The WTRU of claim 1, wherein the first time information indicates a time at which a first packet comprising the first time information was sent.

4-7. (canceled)

8. The WTRU of claim 1, wherein the report information comprises association information indicating that the first flow is associated with the second flow.

9. (canceled)

10. The WTRU of claim 1, wherein the report information further indicates a request for a network policy adjustment associated with any of the first flow and the second flow.

11. The WTRU of claim 1, further configured to determine that the round trip time associated with the first flow and the second flow satisfies a time budget condition.

12. The WTRU of claim 11, wherein being configured to send the report information comprises being configured to send the report information based on the round trip time satisfying the QoS-time budget condition.

13. The WTRU of claim 10, wherein the requested network policy adjustment is associated with a first delay adjustment on the first flow.

14. The WTRU of claim 10, wherein the requested network policy adjustment is associated with a second delay adjustment on the second flow.

15-16. (canceled)

17. A method implemented in a wireless transmit/receive unit (WTRU), the method comprising:
sending, to an extended reality (XR) server, request information indicating a request to replicate time information associated with a first flow and a second flow, wherein the first flow and the second flow are co-dependent;
sending, to the XR server, first time information in the first flow;
receiving, from the XR server, second time information from the second flow, wherein the second time information is a replication of the first time information;
determining a round trip time associated with the first flow and the second flow based on the first time information and the second time information; and
sending, to the XR server, report information indicating the round trip time associated with the first flow and the second flow.

18. The method of claim 17, wherein the request information indicates any of one or more first flow parameters, one or more second flow parameters and one or more action rule parameters.

19. The method of claim 17, wherein the first time information indicates a time at which a first packet comprising the first time information was sent.

20. (canceled)

21. The WTRU of claim 1, wherein the first flow comprises an uplink flow, and wherein the second flow comprises a downlink flow.

22. The method of claim 17, wherein the first flow comprises an uplink flow, and wherein the second flow comprises a downlink flow.

23. The method of claim 17, wherein the report information comprises association information indicating that the first flow is associated with the second flow.

24. The method of claim 17, wherein the report information further indicates a request for a network policy adjustment associated with any of the first flow and the second flow.

25. The method of claim 17, further comprising determining that the round trip time associated with the first flow and the second flow satisfies a time budget condition.

26. The method of claim 25, wherein sending the report information comprises sending the report information based on the round trip time satisfying the time budget condition.

27. The method of claim 24, wherein the requested network policy adjustment is associated with a first delay adjustment on the first flow.

28. The method of claim 24, wherein the requested network policy adjustment is associated with a second delay adjustment on the second flow.
